(19) United States
(12) Patent Application Publication
(10) Pub. No.: US 2026/0119160 A1
(43) Pub. Date: Apr. 30, 2026

(54) DISAGGREGATED ORCHESTRATION FOR HYPERVISOR ROLLING UPGRADES

(71) Applicant: Nutanix, Inc., San Jose, CA (US)

(72) Inventors: Bhuvnesh Jain, Bengaluru (IN); Utkarsh Tripathi, Bengaluru (IN)

(73) Assignee: Nutanix, Inc., San Jose, CA (US)

(21) Appl. No.: 18/972,551

(22) Filed: Dec. 6, 2024

(30) Foreign Application Priority Data
Oct. 24, 2024 (IN) 202441081001

(51) Int. Cl. G06F 8/656; G06F 9/455

(52) U.S. Cl. CPC G06F 8/656; G06F 9/45558; G06F 2009/45595

(57) ABSTRACT

A method may include evacuating compute resources of a first node of the cluster of nodes, in response to evacuating the compute resources of the first node, evacuating storage resources of the first node, in response to evacuating the storage resources of the first node, triggering an upgrade for the first node, during the upgrade of the first node, evacuating compute resources of a second node of the cluster of nodes, and in response to evacuating the compute resources of the second node and restoring the storage and compute resources of the first node, evacuating storage resources of the second node.

### CROSS-REFERENCE TO RELATED APPLICATIONS

This application claims priority to Indian Provisional Application No. 202441081001, filed Oct. 24, 2024, which application is incorporated herein by reference in its entirety.

### BACKGROUND

A hypervisor can run VMs in a cluster by providing compute resources and managing network/storage traffic for the VMs. To upgrade the hypervisor across the cluster without inflicting downtime on VMs, the VMs are moved in a rolling fashion out of the node where the upgrade takes place.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing.

FIG. 1 is a block diagram of an example cluster of a virtual computing system, in accordance with some embodiments of the present disclosure.

FIG. 2 is a block diagram of an example database management system, in accordance with some embodiments of the present disclosure.

FIG. 3 illustrates an example of migrating compute resources within a cluster.

FIG. 4 FIG. 4 is an example graph 400 illustrating upgrade timing for a cluster having ten nodes.

FIG. 5 is a block diagram of example services for executing cluster upgrades.

FIG. 6 is a flow diagram illustrating operations of a method for upgrading nodes of a cluster.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

Hypervisor upgrades, firmware upgrades, or other upgrades within a cluster of nodes are often performed without taking the cluster down. This is down to avoid service interruption, such as application outages due to the cluster being offline. However, to perform a live upgrade of a cluster, the cluster must maintain operation while shutting down individual nodes to perform the hypervisor upgrade. Nodes are generally upgraded in sequence, resulting in long upgrade times that may affect cluster performance.

Embodiments and examples described herein address these technical problems by separating the evacuation of node resources into the evacuation of compute resources and the evacuation of storage resources, allowing for parallel evacuation of resources across different nodes. By evacuating compute resources of a second node while storage resources of a first node are being evacuated, or while the first node is being upgraded, upgrade actions for the nodes in the cluster can be performed in parallel, significantly reducing the total upgrade time for the cluster. As discussed herein, one way to achieve parallel performance of upgrade actions (e.g., evacuation of storage resources, evacuation of compute resources, upgrade) is to allow a compute management service to determine when to evacuate compute resources of the nodes of the cluster and to allow a storage management service to determine when to evacuate storage resources of the nodes of the cluster. This decentralized management of resource evacuation provides for a flexible, efficient evacuation of resources, speeding up the upgrade and reducing an overall upgrade time.

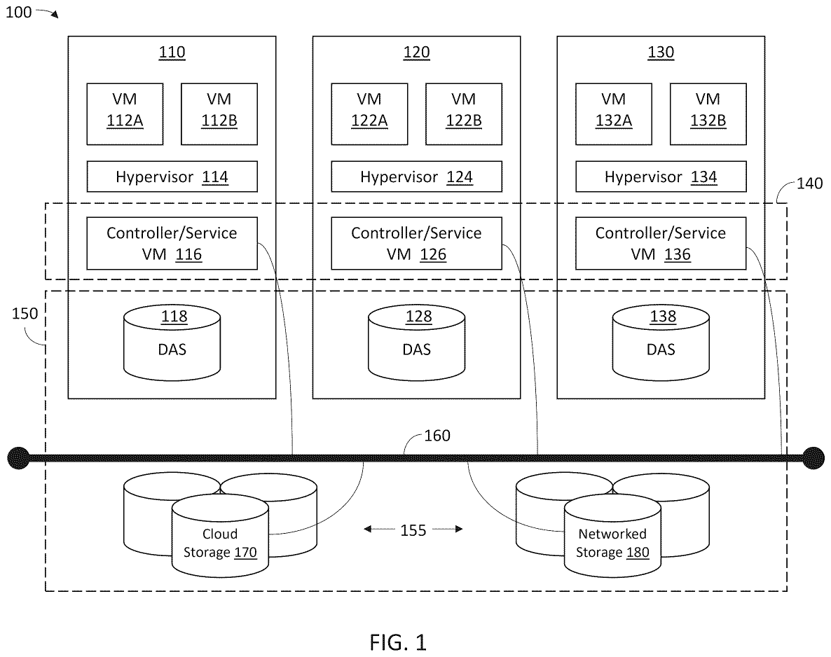

FIG. 1 is a block diagram of an example cluster 100 of a virtual computing system, in accordance with some embodiments of the present disclosure. The cluster 100 may be incorporated in a cloud-based implementation, an on-premises implementation, or a combination of both. An on-premises implementation may be a datacenter that is not part of a cloud. In an example, an organization's servers that it owns and controls for its use can be an on-premises implementation. The cluster 100 may be part of a hyperconverged system or any other type of system. The cluster 100 includes a plurality of nodes, such as a first node 110, a second node 120, and a third node 130. Each of the first node 110, the second node 120, and the third node 130 may also be referred to as a “host” or “host machine.” The first node 110 includes database virtual machines (“database VMs”) 112A and 112B (collectively referred to herein as “database VMs 112”), a hypervisor 114 configured to create and run the database VMs, and a controller/service VM 116 configured to manage, route, and otherwise handle workflow requests between the various nodes of the cluster 100. Similarly, the second node 120 includes database VMs 122A and 122B (collectively referred to herein as “database VMs 122”), a hypervisor 124, and a controller/service VM 126, and the third node 130 includes database VMs 132A and 132B (collectively referred to herein as “database VMs 132”), a hypervisor 134, and a controller/service VM 136. The controller/service VM 116, the controller/service VM 126, and the controller/service VM 136 are all connected to a network 160 to facilitate communication between the first node 110, the second node 120, and the third node 130. Although not shown, in some embodiments, the hypervisor 114, the hypervisor 124, and the hypervisor 134 may also be connected to the network 160. Further, although not shown, one or more of the first node 110, the second node 120, and the third node 130 may include one or more containers managed by a monitor (e.g., container system). In some embodiments, the controller/service VMs 116, 126, and 136 are not included in the cluster 100. The controller/service VMs 116, 126, and 136 may be in a first domain while the VMs 112, 122, and 132 are in a second domain. In an example, the controller/service VMs 116, 126, 136 are in a first cloud, the VMs 112 are in a second cloud, the VMs 116 are in a third cloud, and the VMs 132 are in a fourth cloud. In another example, the controller/service VMs 116, 126, 136 are in a first AWS account and the VMs 112, 122, and 132 are each in different, separate AWS accounts. Thus, the nodes 110, 120, and 130 may be nodes of various public or private clouds, with the controller/service VMs 116, 126, and 136 being separate from the VMs 112, 122, and 132. In an example, the controller/service VMs 116, 126, and 136 host a distributed control plane for managing the VMs 112, 122, and 132, where the VMs 112, 122, and 132 are database server VMs in public cloud accounts separate from a cloud account associated with the control plane.

The controller/service VMs 116, 126, and 136 can be considered a control plane and the VMs 112, 122, and 132 can be considered a data plane. The data plane may include data which is separate from the control logic executed on the control plane. VMs may be added to or removed from the data plane. As discussed above, the control plane and the data plane may be in separate cloud accounts. Different VMs in the data plane may be in separate cloud accounts. In an example, the control plane is in a cloud account of a database management platform provider and the data plane is in cloud accounts of customers of the database management platform provider.

The cluster 100 also includes and/or is associated with a storage pool 150 (also referred to herein as storage sub-system). The storage pool 150 may include network-attached storage 155 and direct-attached storage 118, 128, and 138. The network-attached storage 155 is accessible via the network 160 and, in some embodiments, may include cloud storage 170, as well as a networked storage 180. In contrast to the network-attached storage 155, which is accessible via the network 160, the direct-attached storage 118, 128, and 138 includes storage components that are provided internally within each of the first node 110, the second node 120, and the third node 130, respectively, such that each of the first, second, and third nodes may access its respective direct-attached storage without having to access the network 160.

It is to be understood that only certain components of the cluster 100 are shown in FIG. 1. Nevertheless, several other components that are needed or desired in the cluster 100 to perform the functions described herein are contemplated and considered within the scope of the present disclosure.

Although three of the plurality of nodes (e.g., the first node 110, the second node 120, and the third node 130) are shown in the cluster 100, in other embodiments, greater than or fewer than three nodes may be provided within the cluster. Likewise, although only two database VMs (e.g., the database VMs 112, the database VMs 122, the database VMs 132) are shown on each of the first node 110, the second node 120, and the third node 130, in other embodiments, the number of the database VMs on each of the first, second, and third nodes may vary to include other numbers of database VMs. Further, the first node 110, the second node 120, and the third node 130 may have the same number of database VMs (e.g., the database VMs 112, the database VMs 122, the database VMs 132) or different number of database VMs.

In some embodiments, each of the first node 110, the second node 120, and the third node 130 may include a hardware device, such as a server. For example, in some embodiments, one or more of the first node 110, the second node 120, and the third node 130 may include a server computer provided by Nutanix, Inc., Dell, Inc., Lenovo Group Ltd. or Lenovo PC International, Cisco Systems, Inc., etc. In other embodiments, one or more of the first node 110, the second node 120, or the third node 130 may include another type of hardware device, such as a personal computer, an input/output or peripheral unit such as a printer, or any type of device that is suitable for use in a node within the cluster 100. In some embodiments, the cluster 100 may be part of one or more data centers. Further, one or more of the first node 110, the second node 120, and the third node 130 may be organized in a variety of network topologies. Each of the first node 110, the second node 120, and the third node 130 may also be configured to communicate and share resources with each other via the network 160. For example, in some embodiments, the first node 110, the second node 120, and the third node 130 may communicate and share resources with each other via the controller/service VM 116, the controller/service VM 126, and the controller/service VM 136, and/or the hypervisor 114, the hypervisor 124, and the hypervisor 134.

Also, although not shown, one or more of the first node 110, the second node 120, and the third node 130 may include one or more processing units configured to execute instructions. The instructions may be carried out by a special purpose computer, logic circuits, or hardware circuits of the first node 110, the second node 120, and the third node 130. The processing units may be implemented in hardware, firmware, software, or any combination thereof. The term “execution” is, for example, the process of running an application or the carrying out of the operation called for by an instruction. The instructions may be written using one or more programming languages, scripting languages, assembly language, etc. The processing units, thus, execute an instruction, meaning that they perform the operations called for by that instruction.

The processing units may be operably coupled to the storage pool 150, as well as with other elements of the first node 110, the second node 120, and the third node 130 to receive, send, and process information, and to control the operations of the underlying first, second, or third node. The processing units may retrieve a set of instructions from the storage pool 150, such as, from a permanent memory device like a read only memory (“ROM”) device and copy the instructions in an executable form to a temporary memory device that is generally some form of random access memory (“RAM”). The ROM and RAM may both be part of the storage pool 150, or in some embodiments, may be separately provisioned from the storage pool. In some embodiments, the processing units may execute instructions without first copying the instructions to the RAM. Further, the processing units may include a single stand-alone processing unit, or a plurality of processing units that use the same or different processing technology.

With respect to the storage pool 150 and particularly with respect to the direct-attached storage 118, 128, and 138, each of the direct-attached storage may include a variety of types of memory devices that are suitable for a virtual computing system. For example, in some embodiments, one or more of the direct-attached storage 118, 128, and 138 may include, but is not limited to, any type of RAM, ROM, flash memory, magnetic storage devices (e.g., hard disk, floppy disk, magnetic strips, etc.), optical disks (e.g., compact disk (“CD”), digital versatile disk (“DVD”), etc.), smart cards, solid state devices, etc. Likewise, the network-attached storage 155 may include any of a variety of network accessible storage (e.g., the cloud storage 170, the networked storage 180, etc.) that is suitable for use within the cluster 100 and accessible via the network 160. The storage pool 150, including the network-attached storage 155 and the direct-attached storage 118, 128, and 138, together form a distributed storage system configured to be accessed by each of the first node 110, the second node 120, and the third node 130 via the network 160, the controller/service VM 116, the controller/service VM 126, the controller/service VM 136, and/or the hypervisor 114, the hypervisor 124, and the hypervisor 134. In some embodiments, the various storage components in the storage pool 150 may be configured as virtual disks for access by the database VMs 112, the database VMs 122, and the database VMs 132.

Each of the database VMs 112, the database VMs 122, the database VMs 132 is a software-based implementation of a computing machine. The database VMs 112, the database VMs 122, the database VMs 132 emulate the functionality of a physical computer. Specifically, the hardware resources, such as processing unit, memory, storage, etc., of the underlying computer (e.g., the first node 110, the second node 120, and the third node 130) are virtualized or transformed by the respective hypervisor 114, the hypervisor 124, and the hypervisor 134, into the underlying support for each of the database VMs 112, the database VMs 122, the database VMs 132 that may run its own operating system and applications on the underlying physical resources just like a real computer. By encapsulating an entire machine, including CPU, memory, operating system, storage devices, and network devices, the database VMs 112, the database VMs 122, the database VMs 132 are compatible with most standard operating systems (e.g. Windows, Linux, etc.), applications, and device drivers.

Thus, each of the hypervisor 114, the hypervisor 124, and the hypervisor 134 is a virtual machine monitor that allows a single physical server computer (e.g., the first node 110, the second node 120, third node 130) to run multiple instances of the database VMs 112, the database VMs 122, and the database VMs 132 with each VM sharing the resources of that one physical server computer, potentially across multiple environments. For example, each of the hypervisor 114, the hypervisor 124, and the hypervisor 134 may allocate memory and other resources to the underlying VMs (e.g., the database VMs 112, the database VMs 122, the database VM 132A, and the database VM 132B) from the storage pool 150 to perform one or more functions.

By running the database VMs 112, the database VMs 122, and the database VMs 132 on each of the first node 110, the second node 120, and the third node 130, respectively, multiple workloads and multiple operating systems may be run on a single piece of underlying hardware computer (e.g., the first node, the second node, and the third node) to increase resource utilization and manage workflow. When new database VMs are created (e.g., installed) on the first node 110, the second node 120, and the third node 130, each of the new database VMs may be configured to be associated with certain hardware resources, software resources, storage resources, and other resources within the cluster 100 to allow those virtual VMs to operate as intended.

The database VMs 112, the database VMs 122, the database VMs 132, and any newly created instances of the database VMs may be controlled and managed by their respective instance of the controller/service VM 116, the controller/service VM 126, and the controller/service VM 136. The controller/service VM 116, the controller/service VM 126, and the controller/service VM 136 are configured to communicate with each other via the network 160 to form a distributed system 140. Each of the controller/service VM 116, the controller/service VM 126, and the controller/service VM 136 may be considered a local management system configured to manage various tasks and operations within the cluster 100. For example, in some embodiments, the local management system may perform various management related tasks on the database VMs 112, the database VMs 122, and the database VMs 132.

The hypervisor 114, the hypervisor 124, and the hypervisor 134 of the first node 110, the second node 120, and the third node 130, respectively, may be configured to run virtualization software, such as, ESXi from VMWare, AHV from Nutanix, Inc., XenServer from Citrix Systems, Inc., etc. The virtualization software on the hypervisor 114, the hypervisor 124, and the hypervisor 134 may be configured for running the database VMs 112, the database VMs 122, the database VM 132A, and the database VM 132B, respectively, and for managing the interactions between those VMs and the underlying hardware of the first node 110, the second node 120, and the third node 130. Each of the controller/service VM 116, the controller/service VM 126, the controller/service VM 136, the hypervisor 114, the hypervisor 124, and the hypervisor 134 may be configured as suitable for use within the cluster 100.

The network 160 may include any of a variety of wired or wireless network channels that may be suitable for use within the cluster 100. For example, in some embodiments, the network 160 may include wired connections, such as an Ethernet connection, one or more twisted pair wires, coaxial cables, fiber optic cables, etc. In other embodiments, the network 160 may include wireless connections, such as microwaves, infrared waves, radio waves, spread spectrum technologies, satellites, etc. The network 160 may also be configured to communicate with another device using cellular networks, local area networks, wide area networks, the Internet, etc. In some embodiments, the network 160 may include a combination of wired and wireless communications. The network 160 may also include or be associated with network interfaces, switches, routers, network cards, and/or other hardware, software, and/or firmware components that may be needed or considered desirable to have in facilitating intercommunication within the cluster 100.

Referring still to FIG. 1, in some embodiments, one of the first node 110, the second node 120, or the third node 130 may be configured as a leader node. The leader node may be configured to monitor and handle requests from other nodes in the cluster 100. For example, a particular database VM (e.g., the database VMs 112, the database VMs 122, or the database VMs 132) may direct an input/output request to the controller/service VM (e.g., the controller/service VM 116, the controller/service VM 126, or the controller/service VM 136, respectively) on the underlying node (e.g., the first node 110, the second node 120, or the third node 130, respectively). Upon receiving the input/output request, that controller/service VM may direct the input/output request to the controller/service VM (e.g., one of the controller/service VM 116, the controller/service VM 126, or the controller/service VM 136) of the leader node. In some cases, the controller/service VM that receives the input/output request may itself be on the leader node, in which case, the controller/service VM does not transfer the request, but rather handles the request itself.

The controller/service VM of the leader node may fulfill the input/output request (and/or request another component within/outside the cluster 100 to fulfill that request). Upon fulfilling the input/output request, the controller/service VM of the leader node may send a response back to the controller/service VM of the node from which the request was received, which in turn may pass the response to the database VM that initiated the request. In a similar manner, the leader node may also be configured to receive and handle requests (e.g., user requests) from outside of the cluster 100. If the leader node fails, another leader node may be designated.

Additionally, in some embodiments, although not shown, the cluster 100 may be associated with a central management system that is configured to manage and control the operation of multiple clusters in the virtual computing system. In some embodiments, the central management system may be configured to communicate with the local management systems on each of the controller/service VM 116, the controller/service VM 126, the controller/service VM 136 for controlling the various clusters.

Again, it is to be understood again that only certain components and features of the cluster 100 are shown and described herein. Nevertheless, other components and features that may be needed or desired to perform the functions described herein are contemplated and considered within the scope of the present disclosure. It is also to be understood that the configuration of the various components of the cluster 100 described above is only an example and is not intended to be limiting in any way. Rather, the configuration of those components may vary to perform the functions described herein. For example, in some embodiments, the VMs 112, 122, and 132 are not in the same nodes as the controller/service VMs 116, 126 134. The VMs 112, 122, and 132 may be located in a different cloud than the controller/service VMs 116, 126 134.

The term “cluster” is not limited to the specific examples and implementations described in conjunction with FIG. 1. The term “cluster” can refer to any set of computers that communicate and cooperate to form a single system, where each computer (also referred to as a “node” of the cluster) performs the same tasks to provide increased performance and availability.

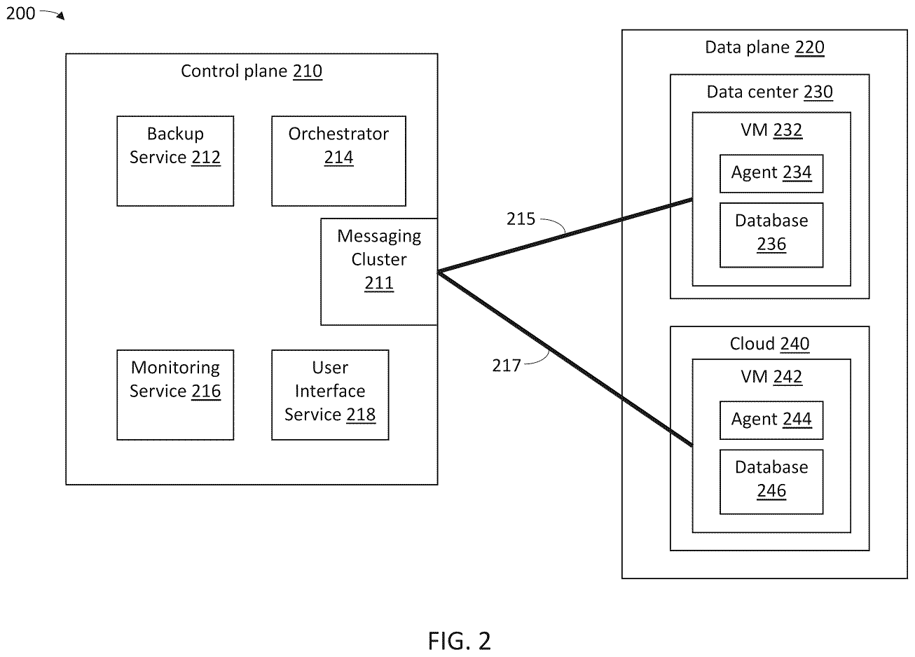

FIG. 2 is a block diagram of an example database management system 200, in accordance with some embodiments of the present disclosure. The database management system 200 may be implemented using one or more clusters, such as the cluster 100 of FIG. 1. In some implementations, one or more components of the database management system 200 are implemented as clusters.

The database management system 200 includes a control plane 210 and a data plane 220. The control plane 210 manages database operations of databases on the data plane 220. The data plane 220 may include databases and virtual machines across multiple different geographies, data centers, public clouds and/or private clouds. Thus, the control plane 210 may manage database operations across multiple different geographies, data centers, public clouds and/or private clouds. The control plane 210 may provide hybrid cloud database management services for databases having instances both on-premises and in public clouds. The control plane 210 may include one or more processors and a memory including computer-readable instructions which cause the one or more processors to perform operations described herein.

The data plane 220 includes a first VM 232 and a second VM 242. The first VM 232 may be hosted in a data center 230. The first VM 232 may be hosted on a cluster such as the cluster 100 of FIG. 1. The second VM 242 may be hosted on a cloud 240 such as a public or private cloud and be associated with a cloud account. The second VM 242 may be hosted on a cluster such as the cluster 100 of FIG. 1. The first VM 232 includes a first agent 234 of the control plane 210 and a first database 236. The first agent 234 receives commands and operations from the control plane 210 and transmits information to the control plane 210 to provide database management services for the first database 236. The second VM 242 includes a second agent 244 of the control plane 210 and a second database 246. The second agent 244 receives commands and operations from the control plane 210 and transmits information to the control plane 210 to provide database management services for the second database 246.

While the data plane 220 is illustrated as including the first VM 232 hosted in the data center 230 and the second VM 242 hosted on the cloud 240, the data plane 220 may manage database operations of (e.g., send commands to) a plurality of VMs hosted across multiple public clouds, private clouds, and/or on-premises systems. Similarly, the data center 230 may host a plurality of VMs and may include one or more on-premises systems and/or components of a public cloud or private cloud. The control plane 210 may be able to manage database operations of the plurality of VMs across the multiple public clouds, private clouds, and/or on-premises systems by sending commands, modified based on the hosting location, to the plurality of VMs. In this way, the control plane 210 provides a unified user interface for managing VMs in a hybrid cloud environment spanning on-premises systems, public clouds, and private clouds.

The first and second VMs 232, 242 may be termed “database servers,” as they serve as virtual database servers for hosting the first and second databases 236, 246. The first and second VMs 232, 242 may be hosted on clusters of nodes, such as the cluster 100 of FIG. 1.

The first agent 234 sends and receives messages from the control plane 210 over a first single communication channel 215. The second agent 244 sends and receives messages from the control plane 210 over a second single communication channel 217. Each of the first and second single communication channels 215, 217 may be single transmission control protocol (TCP) connections. In this way, the control plane 210 is able to open only a single communication channel for each agent associated with each database. Although two VMs are illustrated, the control plane 210 may provide database management services for hundreds, thousands, or millions of VMs. With hundreds of VMs, limiting the number of connections between the control plane 210 and each VM conserves a large amount of compute and network resources.

The control plane 210 includes a messaging cluster 211. The messaging cluster 211 may be a cluster of nodes such as the cluster 100 of FIG. 1 executing a messaging service or messaging application. The messaging cluster 211 may receive messages from the first agent 234 over the first single communication channel 215 and messages from the second agent 244 over the second single communication channel 217. The messaging cluster 211 may isolate messages between different VMs. In an example, the messaging cluster 211 monitors tags, ids, or other indications of origin of the messages to determine that messages from the first agent 234 are received on the first single communication channel 215. In this example, if a message received on the first single communication channel 215 includes an identifier indicating the message originated at a different VM, the message is dropped. Similarly, if a message including an identifier of the first VM 232 is received on the second single communication channel 217 or any other communication channel besides the first single communication channel 215, the message is dropped.

The messaging cluster 211 may direct messages from the first and second VMs 232, 242 to various components of the control plane 210 based on characteristics of the control plane 210. The messaging cluster 211 may include different topics for sending and receiving messages on the first and second single communication channels 215, 217. In an example, the messaging cluster 211 may route messages in an operations topic, a requests topic, and a commands topic.

The control plane 210 includes an orchestrator 214 to orchestrate database management services. In some implementations, the orchestrator 214 may be implemented as a service or container. Similarly, other components of the control plane 210 may be implemented as services or containers. The orchestrator 214 may receive database management service requests from other components of the control plane 210. The orchestrator 214 generates operations and sends the operations and/or commands associated with the operations to the messaging cluster 211. In an example, the orchestrator 214 receives a clone database request for the first VM 232, generates a clone database operation, and sends commands for generating a clone database for the first VM 232 to the messaging cluster 211 for sending to the first agent 234 using the first single communication channel 215.

The control plane 210 includes a backup service 212. The backup service 212 may determine when to generate backups of the first and second VMs 232, 242 and/or when to generate clone databases for the first and second databases 236, 246. The backup service 212 may determine when to generate backups and/or clone databases based on service level agreements (SLAs). In an example, a first SLA for the first VM 232 may cause the backup service 212 to generate and send a backup request for the first VM 232 to the orchestrator 214 every day. In an example, a second SLA for the second VM 242 may cause the backup service 212 to generate and send a backup request for the second VM 242 to the orchestrator 214 every day.

The control plane 210 includes a monitoring service 216. The monitoring service 216 may monitor a status of the first database 236 and/or a status of the second database 246. In some implementations, the second database 246 is a backup database of the first database 236 and the monitoring service 216 monitors the status of the first database 236 in order to determine when to recover the first database 236 using the second database 246 or to perform a failover to the second database 246. The monitoring service 216 may monitor the status of the first database 236 and/or the status of the second database 246 by monitoring messages between the control plane 210 and the first and second databases 236, 246. In an example, if the control plane 210 sends a message to the first database 236 and a response is not received within a predetermined time period, the monitoring service 216 determines that the first database 236 is not available.

The control plane 210 includes a user interface service 218. The user interface service 218 provides an interface for a user of the control plane 210. The user interface service 218 may expose data of the control plane 210 to the user. The user interface service 218 may expose only data associated with the user to the user. The user interface service 218 displays which backups and/or clones are available for recovery. The user interface service 218 may display which backups and/or clones are pending. The user interface service 218 receives user input, such as a selection of a backup for recovery or a selection of an SLA for a VM.

The control plane 210 may include additional components not illustrated. Only the illustrated components are included for clarity. In some implementations, multiple instances of the control plane 210 may be implemented in order to provide database management services to additional virtual machines or databases. In some implementations, the components of the control plane 210 may be services which may be implemented in multiple instances. In this way, the control plane 210 is highly scalable to provide database management services to additional VMs.

In some implementations, the backup service 212 includes backup service entities, or instances on the control plane 210 that are created each time a database is provisioned. Each backup service entity is associated with a database and manages all database management tasks for the associated database. The backup service entity may be a logic construct that handles all data management aspects for the associated database. The backup service entity can handle the creation of backups for the database, the creation of snapshots, and the capture of logs. In some implementations, the backup service entity defines a service level agreement (SLA) or ingest an SLA to be applied to the database. The backup service entity can provide point-in-time recovery (PITR) for the database using the captured snapshots and logs. In an example, a user indicates, using the user interface service 218 that the database is to be restored to a particular point in time, and the backup service entity applies a corresponding snapshot and logs to the database to restore the database to the particular point in time. The backup service entity allows for management of data of the database, providing for users to export some or all of the data of the database (e.g., schema, tables, rows). The database entity can provide metadata management, allowing applications to use the database as a dedicated metadata store. The backup service entity can detect sensitive data in the database. In some implementations, the backup service entity can obscure or mask the sensitive data. The backup service entity may allow for users to specify who can access the database (e.g., access policy). The backup service entity can allow users to set data pipelines, such as data lakes. In an example, the backup service entity performs data processing on data in the database, or orchestrates data processing of the data in the database to send the data to a data store (e.g., data lake, data warehouse). In some implementations, the backup service entity provides data analytics corresponding to usage of the data in the database, an amount of data in the database, changes to the data in the database, and other information.

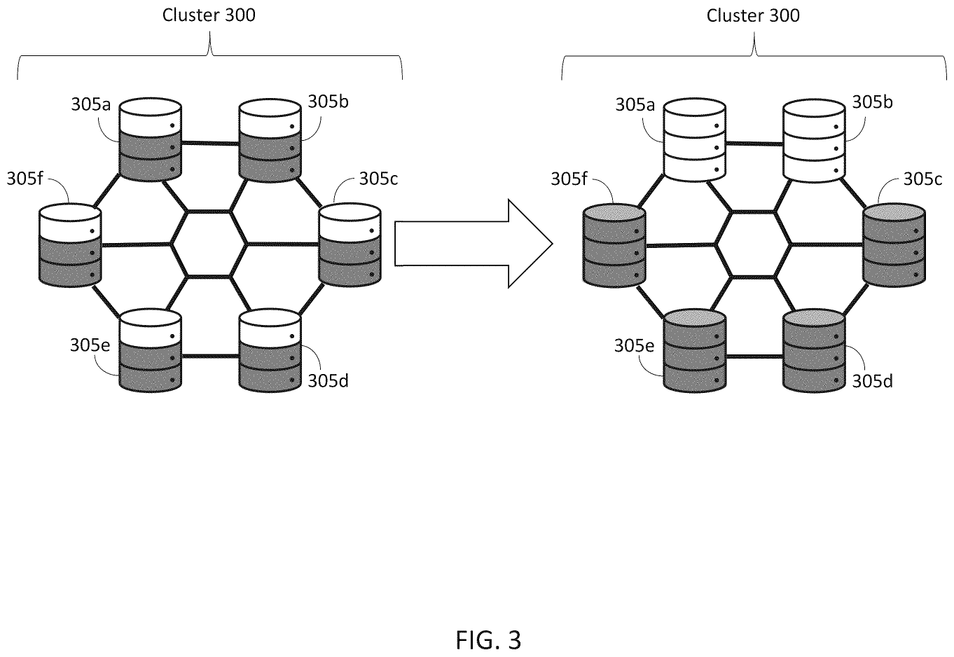

FIG. 3 illustrates an example of migrating compute resources within a cluster 300. The cluster 300 includes six nodes: a first node 305a, a second node 305b, a third node 305c, a fourth node 305d, a fifth node 305e, and a sixth node 305f, referred to collectively herein as the nodes 305. The nodes 305 may each include hardware such as processors, memory (e.g., RAM), and storage (e.g., hard drives). The hardware of the nodes 305 can be virtualized into compute resources and storage resources which can be assigned to VMs for operation. The compute resources may be virtualized from the processors and memory of the nodes 305 and the storage resources may be virtualized from the storage of the nodes 305. Migrating a compute resource or migrating a storage resource from one node to another means to virtualize the compute resource or the storage resource from the hardware of a different node. The number and size of compute resources and/or storage resources on a node depend on the underlying hardware of the node. In an example, a node having eight terabytes of storage can have sixteen storage resources of five hundred gigabytes each. In an example, a node having sixty-four gigabytes of RAM can have eight memory compute resources of eight gigabytes each. Nodes having greater underlying hardware capacity than assigned compute resources or storage resources have unused hardware capacity that is not being utilized by the assigned compute resources or storage resources. Nodes having unused compute resources can be referred to as having “availability of compute resources,” as they have free, unused compute hardware that can be used to accommodate additional compute resources. Nodes having unused storage resources can be referred to as having “availability of storage resources,” as they have free, unused storage hardware that can be used to accommodate additional storage resources. In an example, a node having sixty-four gigabytes of RAM with four memory compute resources of eight gigabytes each has thirty-two gigabytes of RAM that can be used to accommodate additional memory compute resources.

In some implementations, the cluster 300 may host an application and may be a single failure domain for the application. In an example, the cluster 300 may be a single failure domain for the application, such that a failure of a node of the cluster 300 will not cause an outage for the application, but a failure of the cluster 300 will cause an outage for the application.

The nodes 305, prior to migration, are illustrated as each having a third of their underlying compute capacity unused. In other words, each of the nodes 305 has assigned compute resources equal to two-thirds of the capacity of their underlying hardware, meaning that the nodes 305 have availability of compute resources. When the compute resources of the first node 305a and the second node 305b are migrated to other nodes of the nodes 305, the unused capacity of the other nodes is used, allowing for the compute resources of the first node 305a and the second node 305b to be evacuated, or migrated to other nodes. Migrating compute resources while VMs are running can be referred to as a live migration, as the VMs do not experience any interruption. Evacuating storage resources of a node can include redirecting storage and network traffic to another node hosting a copy of the data stored on the node. Evacuating a node can refer to migrating all of the compute resources and/or storage resources of the node.

In conventional systems, a node is evacuated for an upgrade, allowing the node to be upgraded while the VMs of the node run on different nodes of the cluster. Many clusters store copies of storage resources, or data stored in storage resources, in multiple different nodes of a cluster to prevent data loss in the event of a node failure. In many clusters, due to the need for multiple copies of data to be stored on different nodes, only one node can evacuate its storage resources at one time. Thus, upgrading all of the nodes in the cluster (e.g., upgrading the hypervisor on each node in the cluster) requires evacuating the resources of a node, performing the upgrade, restoring the resources of the node, and then proceeding to a subsequent node to sequentially upgrade each node of the cluster. Thus, a conventional system could not take advantage of the fact that the cluster 300 has availability of compute resources sufficient to allow for two nodes to evacuate their compute resources at the same time. However, implementations and examples discussed herein allow for evacuating compute resources and storage resources separately, allowing for faster cluster upgrades. By taking advantage of availability of compute resources to migrate compute resources from multiple nodes simultaneously, the time for the upgrade can be decreased significantly, particularly as the live migration of VMs (i.e., migration of compute resources) typically represents a significant share of upgrade time.

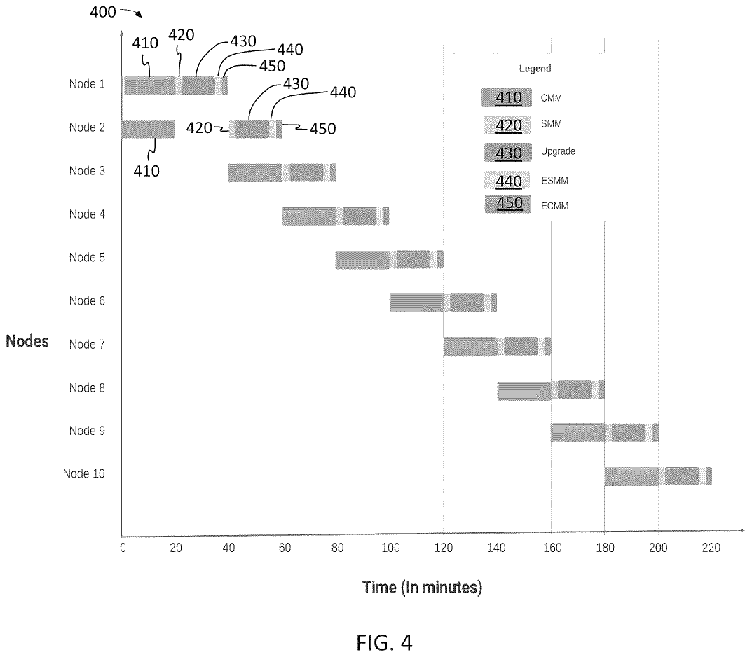

In the example illustrated in FIG. 3, the first node 305a and the second node 305b can have their compute resources evacuated simultaneously. The storage resources of the first node 305a can be evacuated as soon as the compute resources of the first node 305a are evacuated. As the compute resources of the second node 305b were evacuated in parallel with the compute resources of the first node 305a, the storage resources of the second node 305b can be evacuated as soon as the storage resources of the first node 305a are restored. Thus, the total upgrade time can be reduced while still only evacuating the storage resources of a single node at a time. In an example, the storage data of the VMs hosted on the first node 305a is backed up in the second node 305b and the storage data of the VMs hosted on the second node 305b is backed up in the first node 305a. In order to evacuate the storage resources of the first node 305a, the storage and network traffic for the VMs hosted on the first node 305a is redirected to the second node 305b where the storage data is backed up. As the second node 305b hosts the storage data of the VMs of the first node 305a, the second node 305b cannot evacuate its storage resources, but can evacuate its compute resources using the availability of compute resources of the cluster 300. Thus, as soon as the storage resources of the first node 305a are restored (after the hypervisor of the first node 305a is upgraded), the storage resources of the second node 305b can be evacuated without having to wait for evacuation of the compute resources of the second node 305b. An example of an upgrade of a cluster using parallel compute resource evacuation is shown in FIG. 4.

FIG. 4 is an example graph 400 illustrating upgrade timing for a cluster having ten nodes. The graph 400 includes ten nodes on the Y-axis and two hundred and twenty minutes on the X-axis, where actions for the upgrade for each node are illustrated to indicate how much time each action takes, and when each action is performed within the overall upgrade of the cluster.

The actions for each node include a compute maintenance mode (CMM) 410 which corresponds to evacuation of compute resources of VMs of the node such as memory, CPU-states, GPU-states, etc. As discussed herein, the CMM 410 for each node may correspond to a live migration of the VMs of each node. The actions for each node include a storage maintenance mode (SMM) 420 which corresponds to evacuation of storage resources of the node. As discussed herein, evacuation of storage resources of the node can include forwarding storage and network traffic for VMs of the node. Evacuation of storage resources of the node can include bringing down storage services running on the node. The actions for each node include an upgrade 430 which corresponds to an upgrade of the hypervisor of the node. The actions for each node include an exit storage maintenance mode (ESMM) 440 corresponding to restoring the storage resources for each node. Restoring the storage resources for the node includes directing storage and network traffic to the node and bringing up storage and network services for the VMs of the node. The actions for each node include an exit compute maintenance mode (ECMM) 450 corresponding to restoring the compute resources for the node.

For each node, the CMM 410 precedes the SMM 420, and both the CMM 410 and the SMM 420 precede the upgrade 430, as the compute resources and the storage resources need to be evacuated for the upgrade 430 to take place. After the upgrade 430, the ESMM 440 precedes the ECMM 450. As illustrated in the graph 400, the CMM 410 generally occupies the greatest amount of time of all of the upgrade actions for a node, followed by the upgrade 430, with each of the SMM 420, the ESMM 440, and the ECMM 450 taking smaller amounts of time. In an example, each node in the graph 400 takes forty minutes for the upgrade actions, with twenty minutes for the CMM 410, one minute for the SMM 420, seventeen minutes for the upgrade 430, one minute for the ESMM 440, and one minute for the ECMM 450.

As illustrated in the graph 400, the CMM 410 for Node 1 and Node 2 of the cluster occur at the same time. Similar to the cluster 300 of FIG. 3, the cluster for which the upgrade is shown in the graph 400 has enough compute resource availability for two nodes to enter the CMM 410 in parallel. In conventional systems, where the CMM 410 and the SMM 420 are not separated (e.g., referred to simply as “evacuation”), parallel CMM 410 for multiple nodes is generally not possible, as replication requirements for the cluster generally preclude evacuation of storage resources of multiple nodes at the same time. However, by separating the CMM 410 from the SMM 420, multiple nodes can enter the CMM 410, dependent upon the compute resource availability of the cluster. While the graph 400 illustrates two nodes (Node 1 and Node 2) entering the CMM 410 at the same time, any number of nodes could enter or be in the CMM 410 at the same time. The number of nodes in the CMM 410 at any one time is limited only by the underlying hardware of the nodes, or the compute resource availability of the nodes. Similarly, while the graph 400 shows Node 1 and Node 2 entering the CMM 410 at the same time, Node 2 could enter the CMM 410 at any point during the upgrade process of Node 1.

In a cluster where only one node can evacuate its storage resources, or enter the SMM 420 at any one time, such as the cluster for which the upgrade is illustrated in the graph 400, the SMM 420 is the limiting factor for the overall upgrade time. Indeed, by performing CMM 410 on one node in parallel with other upgrade actions (e.g., SMM 420, upgrade 430, ESMM 440, ECMM 450), the upgrade actions other than the CMM 410 on successive nodes can be performed back to back. Thus, parallel execution of the CMM 410 results in the CMM 410 for the nodes not adding any time to the overall cluster upgrade time, apart from the CMM 410 for Node 1. As the CMM 410 can be performed in parallel with other upgrade actions, the CMM 410 is effectively hidden behind the other upgrade actions and does not contribute to the overall cluster upgrade time, except, as noted, the CMM 410 for Node 1. Thus, the CMM 410 for Nodes 2-10 can be performed at any time throughout the overall cluster upgrade, consistent with the sequence of the CMM 410 preceding the SMM 420 for each node. This is advantageous, as the CMM 410 does not have a definite length, but depends upon convergence of the live migration of the VMs of the nodes. Convergence of a live migration refers to transfer of data of a VM during a live migration such that a state of the VM at a destination host is the same as, or converges with, the state of the VM at the origin host, allowing for seamless transfer to the VM at the destination host. As the time to convergence depends upon a rate of change of the data of the VM during the live migration, the length of the CMM 410 is not known in advance. Thus, parallel execution of the CMM 410 that is hidden behind the execution of the other upgrade actions reduces an overall cluster upgrade time. Similarly, if the CMM 410 is longer than the other upgrade actions, the other upgrade actions, performed in parallel with the CMM 410, can effectively be hidden behind the CMM 410. Thus, parallelism between the CMM 410 and the other upgrade actions can reduce the overall upgrade time, whether the CMM 410 or the other upgrade actions in aggregate take longer.

In the graph 400, the SMM 420 of Node 2 begins in response to the ECMM 450 of Node 1 ending, ensuring that only one node is in the SMM 420, or has its storage resources evacuated, at any one time. In response to the ECMM 450 of Node 1 ending, the CMM 410 of Node 3 begins. This pattern continues throughout the cluster upgrade. This pattern may be specific to a cluster where only one node can evacuate its storage resources at any one time, and where only two nodes can evacuate their compute resources at any one time. Different patterns, with greater parallelism, for nodes with looser constraints, are explicitly contemplated and are readily understood based on the graph 400.

In the graph 400, the overall cluster upgrade time is two hundred and twenty minutes. If the same exact cluster upgrade were performed without the parallelism shown in the graph 400, the overall cluster upgrade time would be four hundred minutes. This example illustrates the reduced overall upgrade times as a result of the parallel execution of the CMM 410.

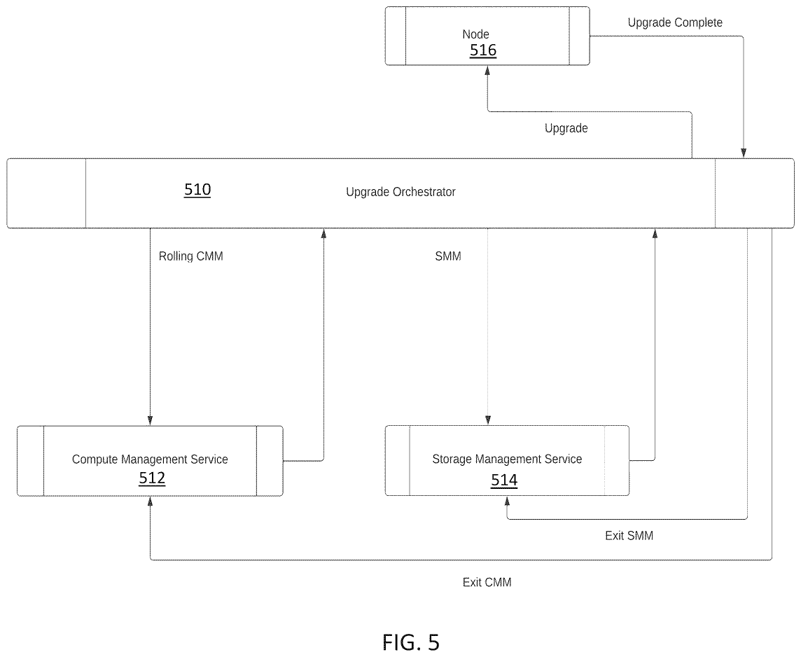

FIG. 5 is a block diagram of example services for executing cluster upgrades. The example services may be executed on the cluster 100 of FIG. 1, on the control plane 210 of FIG. 2, and/or on the cluster 300 of FIG. 3. In an example, the example services of FIG. 5 are executed on the control plane 210 of FIG. 2 and send commands to the cluster 300 of FIG. 3.

The example services include an upgrade orchestrator 510, a compute management service 512, and a storage management service 514. The upgrade orchestrator 510 may manage the upgrade of a cluster. The upgrade orchestrator 510 may manage the upgrade of the cluster using the compute management service 512 and the storage management service 514.

The upgrade orchestrator 510 generates a list of nodes to be upgraded and sends the list of nodes to be upgraded to the compute management service 512. The list of nodes to be upgraded can include all nodes of a cluster. The compute management service 512 determines an availability of compute resources of the cluster to determine a level of parallelism that can be achieved using the availability of compute resources of the cluster. In an example, the compute management service 512 determines that two nodes can evacuate their compute resources in parallel. In an example, the compute management service 512 determines that three nodes can evacuate their compute resources in parallel.

The compute management service 512 evacuates the compute resources of one or more nodes, as constrained by the availability of compute resources of the cluster, and indicates to the upgrade orchestrator 510 which nodes have their compute resources evacuated, or which have entered compute maintenance mode (CMM). The upgrade orchestrator 510 passes a list of nodes in CMM to the storage management service 514. The storage management service 514 evacuates the storage resources of the nodes in the list of nodes in CMM to place the nodes in storage maintenance mode (SMM), as constrained by the storage resource availability of the cluster. As discussed herein, many clusters cannot tolerate more than one node entering SMM at one time, such that the storage management service 514 causes the nodes to enter SMM sequentially.

The storage management service 514 sends an indication of a node (or nodes) in SMM to the upgrade orchestrator 510. The upgrade orchestrator 510 triggers the node upgrade for a current node 516. In some implementations, the upgrade orchestrator 510 sends a command to the current node 516 to download and install the upgrade. When the upgrade is complete on the current node 516, the upgrade orchestrator 510 instructs the storage management service 514 to exit SMM for the current node 516 and instructs the compute management service 512 to exit CMM for the current node 516. In some implementations, the upgrade orchestrator 510 instructs the storage management service 514 to exit SMM for the current node 516, receives an indication from the storage management service 514 that the current node 516 has exited SMM, and then instructs the compute management service 512 to exit CMM for the current node 516. In some implementations, the upgrade orchestrator 510 instructs the storage management service 514 and the compute management service 512 to exit SMM and CMM, respectively, for the current node 516 and the compute management service 512 and the storage management service 514 coordinate to exit SMM before exiting CMM for the current node 516. In some implementations, the upgrade orchestrator 510 instructs the storage management service 514 and the compute management service 512 to exit SMM and CMM, respectively, for the current node 516 and the compute management service 512 and the storage management service 514 exit SMM and exit CMM for the current node 516 in parallel.

Parallelism is achieved due to the compute management service 512 determining when to place nodes in CMM and the storage management service 514 independently determining when to place nodes in SMM. The compute management service 512 can place nodes in CMM based on the compute resource availability of the cluster, independent of the storage resource availability of the cluster. Thus, nodes can be placed in CMM by the compute management service 512 at the same time and/or in parallel with other nodes being placed in SMM or being upgraded. In this way, the upgrade process for the cluster is made faster and more efficient due to the introduction of parallelism between CMM and SMM for different nodes.

Various commands, indications, and communications between the upgrade orchestrator 510, the compute management service 512, and the storage management service 514 can be either pushed and/or pulled between the various services. In an example, the upgrade orchestrator 510 pushes the list of nodes to be upgraded to the compute management service 512 and then periodically polls the compute management service 512 for nodes that are in CMM and periodically polls the storage management service 514 for nodes that are in SMM. Different combinations of pushes and pulls can be used for orchestrating actions performed by the upgrade orchestrator 510, the compute management service 512, and the storage management service 514.

In an example, the compute management service 512 pushes an indication of nodes in CMM to the storage management service 514 and also sends the indication of nodes in CMM to the upgrade orchestrator 510.

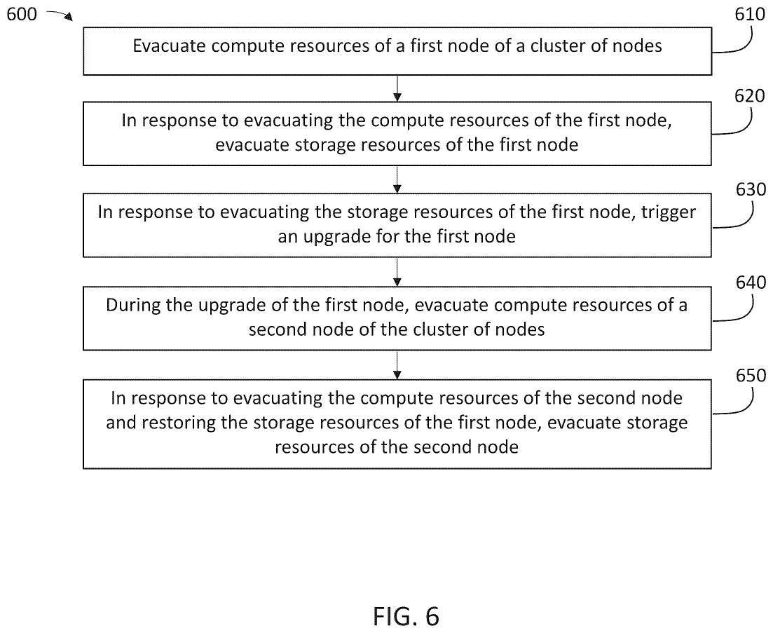

FIG. 6 is a flow diagram illustrating operations of a method 600 for upgrading nodes of a cluster. The method 600 may include more, fewer, or different operations than shown. The operations may be performed in the order shown, in a different order, or concurrently. The method 600 may be performed by the cluster 100 of FIG. 1, the control plane 210 of FIG. 2, and/or the services of FIG. 5.

At operation 610, compute resources of a first node of a cluster of nodes are evacuated. As discussed herein, evacuation of the compute resources of the first node can include live migration of VMs hosted on the first node. In some implementations, the cluster of nodes defines a single failure domain. In an example, the cluster of nodes may be a single failure domain for an application, such that a failure of a node of the cluster will not cause an outage for the application, but a failure of the cluster will cause an outage for the application.

At operation 620, in response to evacuating the compute resources of the first node, storage resources of the first node are evacuated. As discussed herein, evacuation of the storage resources of the first node can include directing network and storage traffic of VMs of the first node to another node of the cluster where storage data of the VMs of the first node is backed up or replicated.

At operation 630, in response to evacuating the storage resources of the first node, an upgrade for the first node is triggered. The upgrade of the first node may be performed when the VMs of the node are hosted elsewhere in the cluster, and when the compute and storage resources of the first node have been evacuated.

At operation 640, during the upgrade of the first node, compute resources of a second node of the cluster of nodes are evacuated. In some implementations, the evacuation of the compute resources of the second node begins during the evacuation of the compute resources of the first node. In some implementations, the evacuation of the compute resources of the second node begins during the evacuation of the storage resources of the first node. In some implementations, the evacuation of the compute resources of the second node begins during the upgrade of the first node. The evacuation of the compute resources of the second node can be performed in parallel with the upgrade actions of the first node, including the evacuation of the resources of the first node and the upgrade of the first node. As discussed herein, the compute management service determines when nodes enter CMM, or when the compute resources of nodes are evacuated. When parallel CMM is possible, or when two or more nodes of the cluster can be in CMM at the same time, the compute management service can put the second node in CMM during the upgrade of the first node, or at any time based on resource availability.

At operation 650, in response to evacuating the compute resources of the second node and restoring the storage resources of the first node, storage resources of the second node are evacuated. The storage resources of the first node may be restored in response to the upgrade of the first node being completed. As discussed herein, many clusters cannot tolerate more than one node having its storage resources evacuated at one time. Evacuating the storage resources of the second node in response to restoring the storage resources of the first node can ensure that only one node of the cluster has its storage resources evacuated at one time. In a cluster where more than one node can have its storage resources evacuated at one time, evacuating the storage resources of the second node in response to restoring the storage resources of the first node can ensure that the maximum number of nodes that can have their storage resources evacuated at one time is not exceeded.

In some implementations, the method 600 includes, in response to restoring the storage resources of the first node, restoring the compute resources of the first node. Restoring the storage resources and the compute resources of the first node allows the VMs of the first node to be hosted on the first node. In some implementations, evacuating the storage resources of the second node is performed in response to evacuating the compute resources of the second node, restoring the storage resources of the first node, and restoring the compute resources of the first node. In this way, the storage resources of the second node are evacuated in response to the first node being fully operational once more.

In some implementations, the method 600 includes evacuating compute resources of a third, unupgraded node of the cluster of nodes in response to restoring compute resources of the first node. All of the nodes of the cluster can be upgraded in this manner, with a subsequent node evacuating its compute resources in response to a previous node restoring its compute resources, and with the subsequent node evacuating its storage resources in response to another previous node restoring its storage resources. As discussed herein, decentralized control of resource evacuation allows for parallelism between nodes of resource evacuation and upgrade. In this way, the total upgrade time for the cluster can be greatly reduced.

In some implementations, the method 600 includes determining a number of nodes for which compute resources can be evacuated in parallel. This determination can be made by a service that manages the compute resources for the cluster, such as the compute management service 512 of FIG. 5. In some implementations, the method 600 includes determining a number of nodes for which storage resources can be evacuated in parallel. This determination can be made by a service that manages the storage resources for the cluster, such as the storage management service 514 of FIG. 5. In some implementations, the method 600 includes determining a first number of nodes for which compute resources can be evacuated in parallel and/or a second number of nodes for which storage resources can be evacuated in parallel. These determinations may define how much parallelism the cluster can tolerate during the cluster upgrade, and thus how quickly the entire cluster can be upgraded.

The foregoing detailed description includes illustrative examples of various aspects and implementations and provides an overview or framework for understanding the nature and character of the claimed aspects and implementations. The drawings provide illustration and a further understanding of the various aspects and implementations and are incorporated in and constitute a part of this specification.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The terms “computing device” or “component” encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a model stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the monitoring device 102) to perform actions by operating on input data and generating an output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks. The processor and the memory can be supplemented by, or incorporated in, special purpose logic circuitry.

While operations are depicted in the drawings in a particular order, such operations are not required to be performed in the particular order shown or in sequential order, and all illustrated operations are not required to be performed. Actions described herein can be performed in a different order. The separation of various system components does not require separation in all implementations, and the described program components can be included in a single hardware or software product.

The phraseology and terminology used herein is for the purpose of description and should not be regarded as limiting. Any references to implementations or elements or acts of the systems and methods herein referred to in the singular may also embrace implementations including a plurality of these elements, and any references in plural to any implementation or element or act herein may also embrace implementations including only a single element. Any implementation disclosed herein may be combined with any other implementation or embodiment.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A method for upgrading a cluster of nodes, the method comprising:
evacuating compute resources of a first node of the cluster of nodes;
in response to evacuating the compute resources of the first node, evacuating storage resources of the first node;
in response to evacuating the storage resources of the first node, triggering an upgrade for the first node;
during the upgrade of the first node, evacuating compute resources of a second node of the cluster of nodes; and
in response to evacuating the compute resources of the second node and restoring the storage resources of the first node, evacuating storage resources of the second node.

2. The method of claim 1, wherein evacuating the compute resources of the second node begins during the evacuation of the compute resources of the first node.

3. The method of claim 1, wherein evacuating the compute resources of the second node occurs during the evacuation of the storage resources of the first node.

4. The method of claim 1, further comprising, in response to restoring the storage resources of the first node, restoring the compute resources of the first node, wherein evacuating the storage resources of the second node is performed in response to evacuating the compute resources of the second node, restoring the storage resources of the first node, and restoring the compute resources of the first node.

5. The method of claim 1, further comprising, in response to restoring compute resources of the first node, evacuating compute resources of a third node of the cluster of nodes.

6. The method of claim 1, further comprising determining at least one of a first number of nodes for which compute resources can be evacuated in parallel and a second number of nodes for which storage resources can be evacuated in parallel.

7. The method of claim 1, wherein the cluster of nodes comprises a single failure domain.

8. A non-transitory, computer-readable medium including instructions which, when executed by one or more processors, cause the one or more processors to:
evacuate compute resources of a first node of the cluster of nodes;
in response to evacuating the compute resources of the first node, evacuate storage resources of the first node;
in response to evacuating the storage resources of the first node, trigger an upgrade for the first node;
during the upgrade of the first node, evacuate compute resources of a second node of the cluster of nodes; and
in response to evacuating the compute resources of the second node and restoring the storage resources of the first node, evacuate storage resources of the second node.

9. The non-transitory, computer-readable medium of claim 8, wherein the instructions cause the one or more processors to begin evacuating the compute resources of the second node during the evacuation of the compute resources of the first node.

10. The non-transitory, computer-readable medium of claim 8, wherein the instructions cause the one or more processors to evacuate the compute resources of the second node during the evacuation of the storage resources of the first node.

11. The non-transitory, computer-readable medium of claim 8, wherein the instructions cause the one or more processors to, in response to restoring the storage resources of the first node, restore the compute resources of the first node, and wherein the instructions cause the one or more processors to evacuate the storage resources of the second node in response to evacuating the compute resources of the second node, restoring the storage resources of the first node, and restoring the compute resources of the first node.

12. The non-transitory, computer-readable medium of claim 8, wherein the instructions cause the one or more processors to, in response to restoring compute resources of the first node, evacuate compute resources of a third node of the cluster of nodes.

13. The non-transitory, computer-readable medium of claim 8, wherein the instructions cause the one or more processors to determine at least one of a first number of nodes for which compute resources can be evacuated in parallel and a second number of nodes for which storage resources can be evacuated in parallel.

14. The non-transitory, computer-readable medium of claim 8, wherein the cluster of nodes comprises a single failure domain.

15. A system comprising:
one or more processors; and
a non-transitory, computer-readable medium including instructions which, when executed by the one or more processors, cause the one or more processors to:
evacuate compute resources of a first node of the cluster of nodes;
in response to evacuating the compute resources of the first node, evacuate storage resources of the first node;
in response to evacuating the storage resources of the first node, trigger an upgrade for the first node;
during the upgrade of the first node, evacuate compute resources of a second node of the cluster of nodes; and
in response to evacuating the compute resources of the second node and restoring the storage resources of the first node, evacuate storage resources of the second node.

16. The system of claim 15, wherein the instructions cause the one or more processors to begin evacuating the compute resources of the second node during the evacuation of the compute resources of the first node.

17. The system of claim 15, wherein the instructions cause the one or more processors to evacuate the compute resources of the second node during the evacuation of the storage resources of the first node.

18. The system of claim 15, wherein the instructions cause the one or more processors to, in response to restoring the storage resources of the first node, restore the compute resources of the first node, and wherein the instructions cause the one or more processors to evacuate the storage resources of the second node in response to evacuating the compute resources of the second node, restoring the storage resources of the first node, and restoring the compute resources of the first node.

19. The system of claim 15, wherein the instructions cause the one or more processors to, in response to restoring compute resources of the first node, evacuate compute resources of a third node of the cluster of nodes.

20. The system of claim 15, wherein the instructions cause the one or more processors to determine at least one of a first number of nodes for which compute resources can be evacuated in parallel and a second number of nodes for which storage resources can be evacuated in parallel.

21. The system of claim 15, wherein the cluster of nodes comprises a single failure domain.
